(19) United States
(12) Patent Application Publication
(10) Pub. No.: US 2005/0006877 A1
(43) Pub. Date: Jan. 13, 2005

(54) Portable shopping cart and platform truck

(76) Inventor: Oliver B. Kachkovsky, Palm Coast, FL (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/859,455

(22) Filed: Jun. 2, 2004

Related U.S. Application Data
(60) Provisional application No. 60/474,344, filed on Jun. 2, 2003.

(51) Int. Cl. B62B 3/02

(52) U.S. Cl. 280/641; 280/651

(57) ABSTRACT

A convertible cart a back frame assembly, a collapsible platform pivotally attached to the back frame assembly, a plurality of wheels rotatably attached to at least one of the back frame assembly and the collapsible platform, and a collapsible container attached to the back frame assembly and the collapsible platform. The back frame assembly, the collapsible platform and the collapsible container define a partially enclosed region.

### RELATED APPLICATIONS

This application claims the benefit of U.S. Provisional Patent Application Ser. No. 60/474,344 entitled “Shopping Cart and Platform Cart”, filed Jun. 2, 2003, hereby fully incorporated herein by reference.

### FIELD OF THE INVENTION

This invention relates to foldable four wheeled handcarts that can be easily converted to a four-wheeled container cart. More particularly, the invention pertains to a convertible carrier that can be used as a platform cart, a shopping cart or utility cart, and then collapse the carrier to compact dimensions for storage and/or transport.

### BACKGROUND OF THE INVENTION

Various types of handcarts and dollies have been developed to assist in moving large items from one location to another. Such handcarts are used in factory, office, warehouse, store and home environments and can be of various size and shape, dependent upon the load that is to be transported. However, such handcarts are not practical for transporting numbers of smaller items at one time. For example, use of a handcart or dolly is not an efficient or practical way to transport groceries, laundry, toys and the like. A cart or wagon used to transport numbers of smaller objects generally has sidewalls and a closed bottom forming a container in which the smaller items cant be placed.

At different times, it may be necessary to transport a mixture of items; both large items and a number of smaller items. As a result, more than one type of handcart may be required to move the various sized items. It would be advantageous to have one such handcart that could be easily converted from one type of handcart resembling a dolly or platform cart, to a handcart more closely resembling a shopping cart or laundry cart. More particularly, it would be advantageous to have one handcart that could be configured to transport most any type of item. Further, it would be desirable if the handcart could also be folded into a compact configuration for storage, for hand carrying, or for transport in a vehicle, such as an automobile trunk.

A variety of foldable, wheeled carts have been developed in order to try to meet the needs of the marketplace. Examples of prior art foldable handcarts of varying description may be found in U.S. Patent Nos. 2001/0011802A1 to Meabon; U.S. Pat. No. 2,767,996 to Seyforth; U.S. Pat. No. 3,194,576 to Kunkle; U.S. Pat. Nos. 3,743,312; 4,136,889 to Middleton; U.S. Pat. No. 4,448,434 to Anderson; U.S. Pat. No. 4,570,961 to Chateauneuf et al.; U.S. Pat. No. 6,053,515 to Kelley; U.S. Pat. No. 6,152,462 to Barrett; U.S. Pat. No. 6,267,393 to Mengrone et al.; and U.S. Pat. No. 6,419,244 to Meabon; all of which are hereby fully incorporated by reference.

Prior art wheeled handcarts typically include a pair of upright frame members, each having a handle and a wheel at opposite ends. Many of these carts have only two wheels, which necessitates balancing the load on the cart while wheeling the cart. The handles and wheels extend in the same direction from the upright frame. A load carrying plate or bracket extends from the wheel-end of the frame members, in the direction opposite the wheels and handles. There may be a number of braces extending between the upright frame members to provide additional support to the load being transported on the handcart or dolly.

To be able to use the upright handcart as a transporting receptacle, the handcart is often placed in a horizontal position and additional structures must be added to the basic handcart. For example, in U.S. Patent Nos. 2001/0011802A1 and U.S. Pat. No. 6,419,244 an additional wheel must be added to the cart chassis, if the cart is to be used in the horizontal position as a transport container. In addition, a handle may need to be added so that the handcart can be maneuvered when the handcart is oriented in a horizontal configuration.

In U.S. Pat. No. 3.743,312, a dolly-type handcart can be reconfigured to a wheelbarrow-type transport container by the addition of the wheelbarrow tub. The wheelbarrow tub may already have a wheel secured to its forward bottom section or the wheels of the handcart can be reconfigured and used to drive the cart.

U.S. Pat. No. 4,136,889 similarly provides for a dolly-type handcart that has upright frame members and bars that can be adjusted to effectively shift the position of the wheels when the reconfigured frame is in a horizontal position. A receptacle can then be mounted on the horizontal frame and the unit can be used as a wheelbarrow-type cart.

A dolly-type handcart in the prior art that is collapsible and convertible to a container-type cart is described in U.S. Pat. No. 4,448,434. The dolly-type handcart also has two elevated, load-carrying brackets connected to and positioned between the upright frame members of the cart, proximate the handles. When in use, the brackets are rotated to extend outwardly from the upright frame members on the side opposite the handles and wheels. Each bracket has an extension pivotally attached to the bracket such that the extension nests over the upper surface of the bracket. A soft container such as a sack can be positioned over the bracket and held in place by the bracket extension.

The above-noted dolly-type handcarts, although convertible to horizontally-oriented container-type carts, require various additional structural pieces to effect the conversion. The added pieces can include wheels or wheel assemblies, a receptacle, a handle and the like. In addition, the dollies and some of the container carts have only two wheels. Therefore it is necessary to be able to balance the load on the dolly or in the receptacle when transporting the load.

### SUMMARY OF THE INVENTION

In preferred embodiments of the invention, a collapsible four-wheeled container cart is convertible into a four-wheeled platform cart (or vice-versa), without the addition of structural parts or the need for tools to effect the conversion. The platform of the cart is hingedly attached to a back frame assembly, the platform being supported by two wheel assemblies distal to the back frame assembly.

The back frame assembly, comprising an extended U-shaped handle, two vertical arms positioned proximate the outer surface of the handle upright members and connected to the handle via a top plate, and a back panel positioned intermediate the two vertical arms, has a spaced-apart pair of wheels at its lower end. The bottom of a leather or fabric container is removably attached to the platform of the cart.

The container has a side support that diagonally traverses the container sides and crosses the front of the container. The side support is hingedly attached to the cart back frame assembly such that when the bottom of the container is disengaged from the platform, collapsed, and folded vertically proximate the back frame assembly, the side support provides some support to keep the fabric container in place.

The container cart is thus converted into a platform cart. To convert the platform cart to its storage configuration, the platform is folded up to a vertical position proximate the back frame assembly, with the folded container positioned intermediate the back frame assembly and the vertically positioned platform.

A feature and advantage of the invention is that the conversion of the container cart to a platform cart, or from a platform cart to a container cart, requires no tools and no additional parts. The convertible cart is completely self-contained. Hence, the cart can be converted between its two operational configurations at any time and at any place.

A further feature and advantage is that the cart is collapsible for transport or storage without the need of tools to effect the change in configuration. The collapsed cart can fit inside the typical automobile trunk and requires little storage space.

A further feature and advantage is that the cart can be made of plastic material, which weighs less than metal, does not rust, and does not make noise during use as compared to metal/wire container/shopping carts. The use of plastic results in an easily transportable, relatively lightweight cart.

A further feature and advantage is that the platform cart and the container cart configurations have four wheels and do not require balancing the load on just two wheels during transport.

A further feature and advantage is that the capacity of the container on the cart is greater than the capacity of the average collapsible shopping cart.

A further feature and advantage of the invention is that the mechanisms whereby the container cart is formed or the platform cart is collapsed are easily deployed.

### DESCRIPTION OF THE DRAWINGS

FIG. 1 is a perspective view of a collapsible cart in an unfolded configuration.

FIG. 2 is a perspective view of the cart in a collapsed configuration.

FIG. 3 is a perspective view of the collapsible cart in a platform cart configuration.

FIG. 4 is an exploded view of an undersurface of a platform for the collapsible cart.

FIG. 5 is a perspective view of a locking mechanism when the collapsible cart is in an operational configuration.

FIG. 6 is a side plan close-up view of a top section of the locking mechanism.

FIG. 7 is a close-up side plan view of a bottom section of the locking mechanism.

FIG. 8 is a side plan view of the locking mechanism when the collapsible cart is in the collapsed configuration.

FIG. 9 is an exploded view of the collapsible cart.

FIG. 10 is a perspective view of a top plate and a lock assembly for the collapsible cart.

FIG. 11 is a close-up exploded perspective view of the lock assembly.

### DESCRIPTION OF THE INVENTION

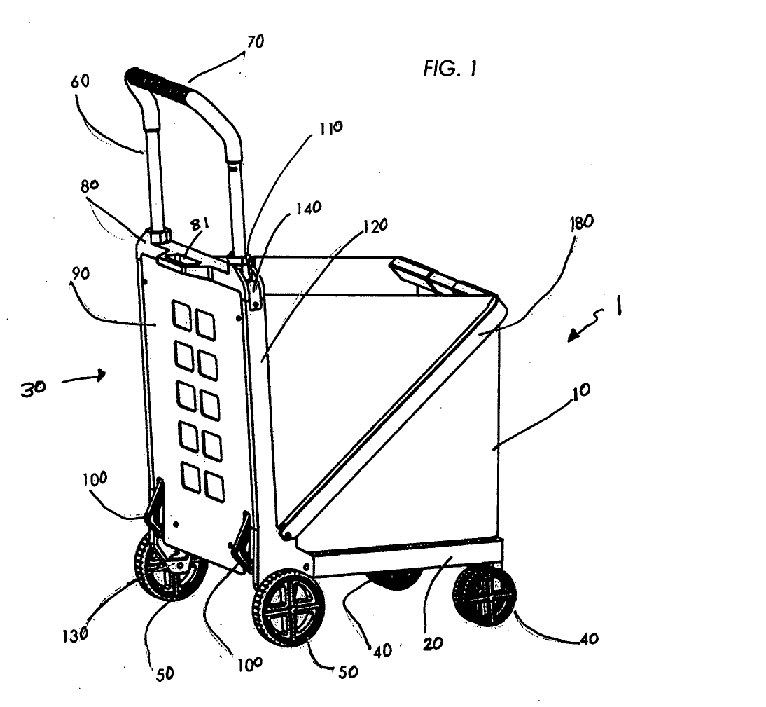

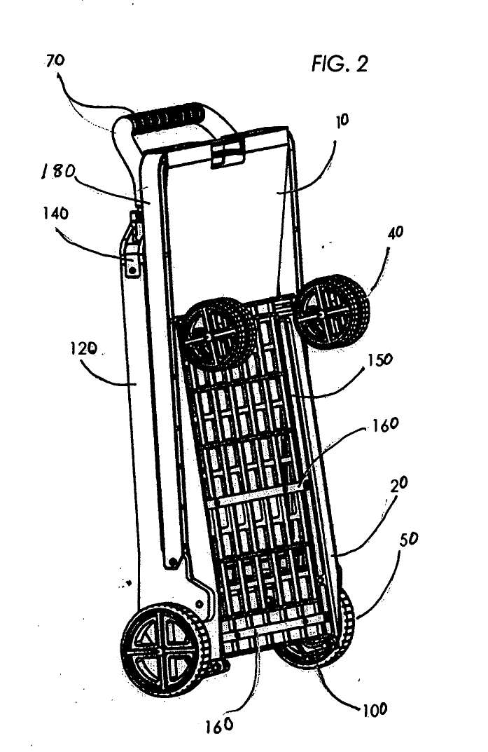

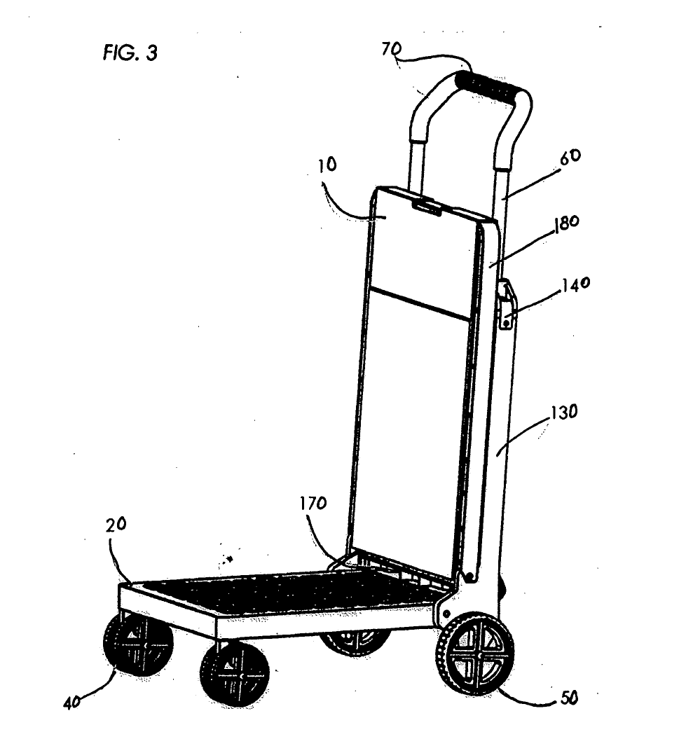

Referring to FIGS. 1-3, the invention includes a collapsible cart 1 that is configured as a container/shopping cart and, alternatively, as a platform cart. The collapsible cart 1 comprises a platform 20, a flexible container 10 and a back frame assembly 30.

A bottom of the container 10 rests on the top of the platform 20 when the container 10 is extended and operational. When the container 10 is not operational, the container 10 is folded and stored vertically, abutting the back frame assembly 30. When the cart 1 is collapsed for storage and/or transport, the platform 20 folds up to a vertical position, abutting the back frame assembly 30 and sandwiching the folded container 10 therebetween.

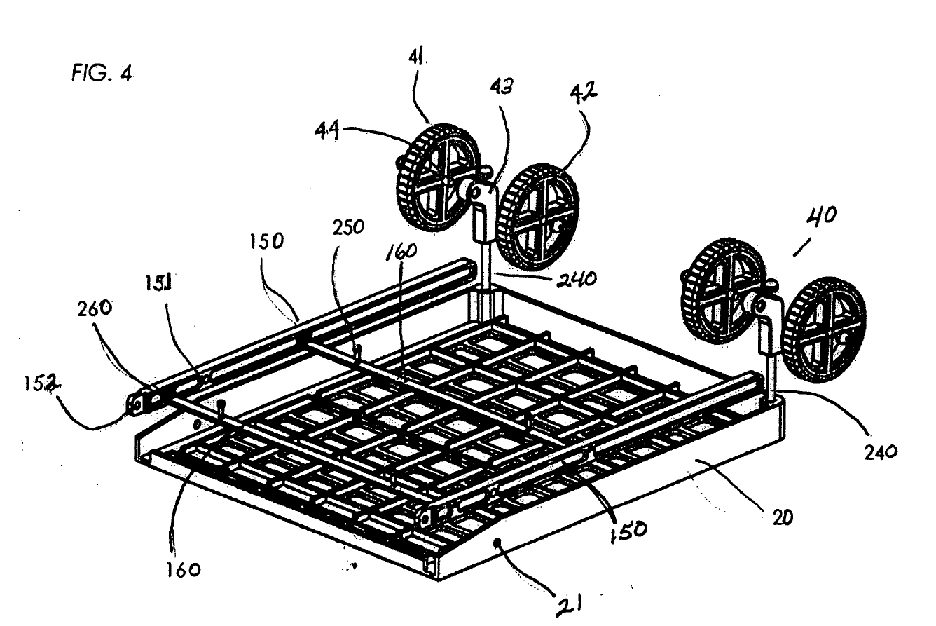

The platform 20 shown generally in FIGS. 1-4 has a pair of wheel assemblies 40 attached to the underside of the platform 20, distal to the back frame assembly 30. Each wheel assembly is comprised of a left swivel wheel 41, a right swivel wheel 42, a wheel support bracket 43 and a connector pin 44. The wheel support bracket 43 is positioned intermediate the left swivel wheel 41 and the right swivel wheel 42 such that the hole in the wheel support bracket 43 aligns with the hole in the center of the left swivel wheel 41 and the hole in the right swivel wheel 42. The pin 44 passes through the left swivel wheel 41, the wheel support bracket 43 and the right swivel wheel 42, such that the wheels are concentrically aligned. A press-fitted cap (not shown) is preferably affixed onto the pin 44 to secure the various parts of the wheel assembly into a complete unit.

The underside of the platform 20 has two pins 240 integrally formed with the platform 20, one pin 240 in each corner that is proximate the distal edge of the platform 20. The pins 240 are positioned substantially perpendicularly to the underside of the platform 20. The tubular end of the wheel support bracket 43 of the wheel assembly 40 is placed over a pin 240 and is secured with a press-fitted cap.

Two spaced-apart pivot-bars 150 are located along either side of the length of the platform 20, on the underside of the platform 20. Two spaced apart connecting bars 160 are oriented perpendicularly to the pivot-bars 150, between the two pivot-bars 150. Screws 260 affix opposite ends of each connecting bar 160 to the pivot-bars 150. One connecting bar 160 is preferably located proximate the end of the pivot-bars 150, opposite the wheeled edge of the platform 20. The second connecting bar 160 is preferably located proximate the wheeled edge of the platform 20 as compared to the first connecting bar 160. A total of four screws 250, two in each connecting bar 160, preferably join each connecting bar 160 to the underside of the platform 20.

Each pivot bar 150 contains a tab extension located at the end of the bar distal to the wheeled end of the platform 20. The tab contains hole 152. In addition, a hole 151 is located in the side of each pivot-bar 150, between the two connecting bars 160. Hole 21 is located on each side panel of the platform, distal from the wheeled end of the platform 20.

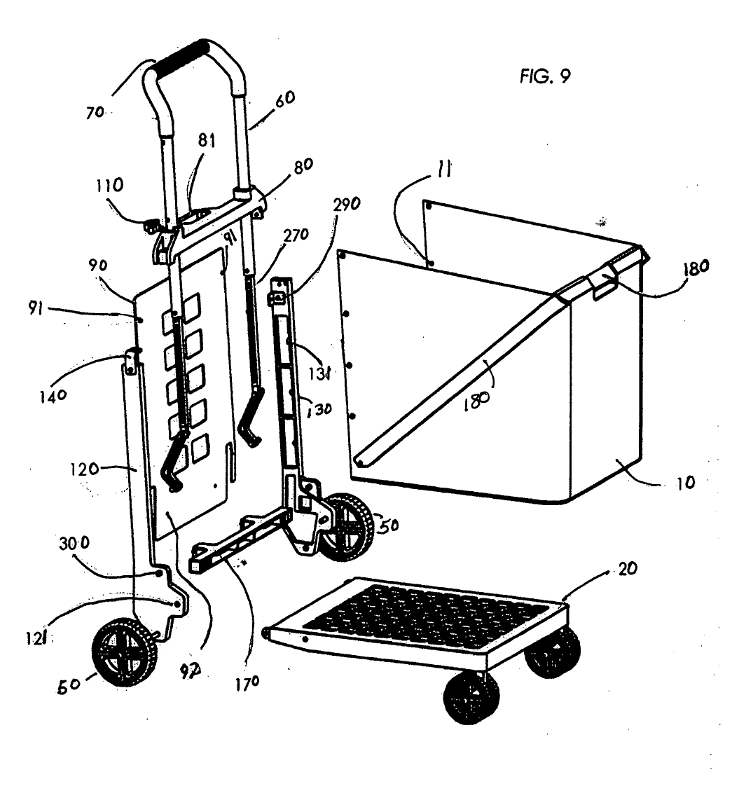

As shown in FIG. 9, the back frame assembly is comprised of a back frame panel 90, two vertical arms 120, 130, and an extended U-shaped handle 60. The back panel 90 is positioned intermediate the two vertical arms 120, 130, and affixed to the arms. A bracket 290 at the top of each vertical arm 120, 130, is aligned with a hole at the top of the back panel 90, and a screw 91 is threaded through the panel hole and the bracket, thus securing the back panel 90 to each of the vertical arms 120, 130.

Each vertical arm 120, 130 contains an integral pin located at the base of the arms 120, 130, and oriented perpendicularly to the outer surface of the arms 120, 130. A rear wheel 50 is inserted over each pin and secured to the arms 120, 130 via a press-fitted closing cap. The ends of a stop-bar 170 are inserted into cavities formed in the interior side of the base of the two vertical arms 120, 130. The lower portion of the back panel 90 is attached to the stop-bar 170 via two screws 92.

The extended U-shaped tubular handle 60 is attached to the two vertical arms 120, 130 via brackets 140 affixed to the top and extending from the vertical arms 120, 130. The free ends of the brackets 140 are secured to the top plate 80 portion of the U-shaped handle via a set of screws.

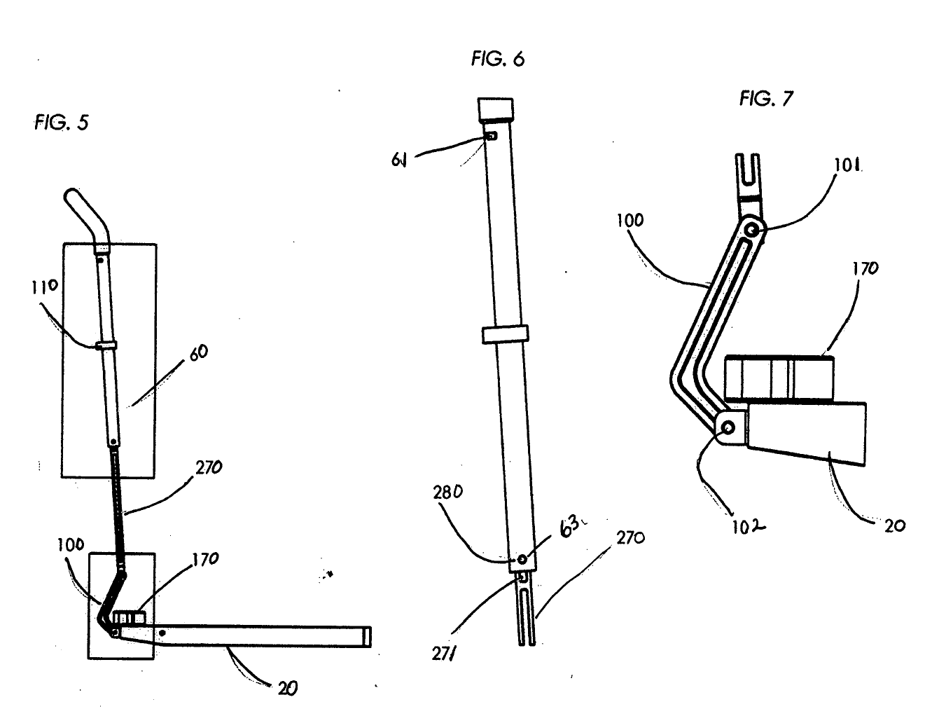

As shown in FIGS. 5, 6, and 9, two guiders 270 are inserted into the lower tubular ends of handle 60, further extending the length of the handle 60. Two pins 280 are press-fitted into holes 63 in the handle 60 and pass through the slots 271 at the top of the guiders 270, thus securing the guiders 270 to the extended handle 60.

As best shown in FIG. 7, tabs at the lower end of the guiders are connected to hinges 100 by pins passing through holes 101. Alternatively, the upright members of the handle 60 can be extended to connect to hinges 100. The holes 102 at the lower end of the hinges are aligned with holes 152 of the pivot-bars 150 and secured by pins, thus connecting the hinges 100 to the pivot-bars 150 and, consequently, to the platform 20. This last link completes the connection of the handle 60 to the platform 20, via the guiders 270, the hinges 100, and the pivot-bars 150. The back panel 90 contains two cut-outs at its lower edge to accommodate the hinge 100 portion of the connective linkage. This entire mechanism is best shown in FIG. 5.

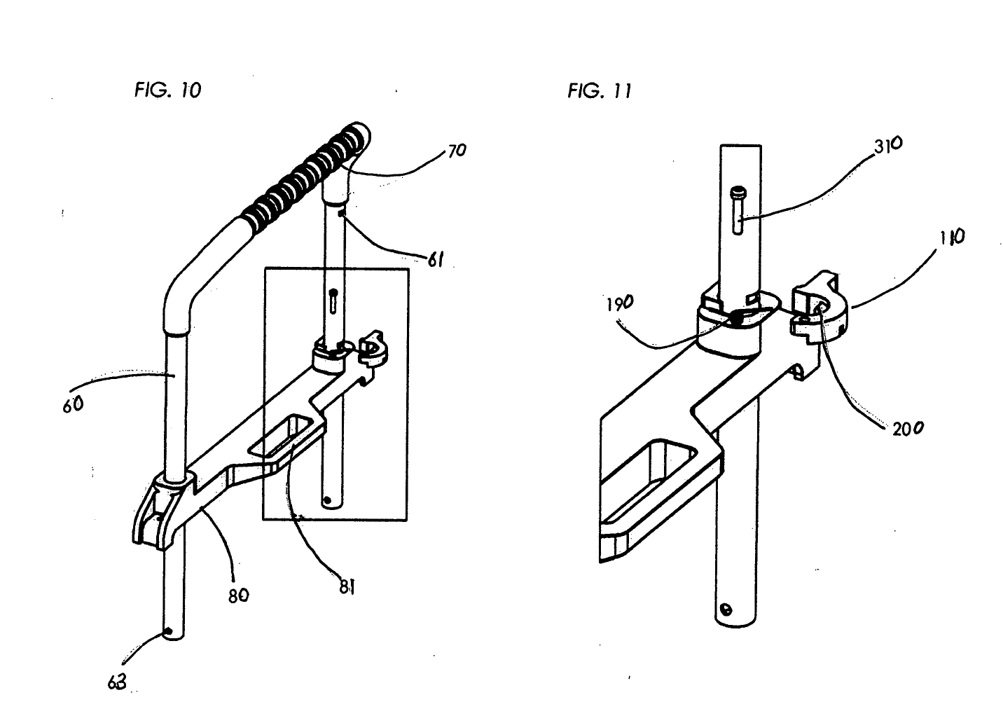

As best shown in FIGS. 10 and 11, the upright members of U-shaped handle 60 pass through two holes or round openings in the top plate 80, such that movement of the members is allowed through the openings. The top plate 80 is secured to the two arms 120, 130 by two brackets 140 and screws. The top plate 80 contains an integral grab handle 81 that provides support when the platform cart is collapsed closed.

A locking mechanism is attached to the top of the right opening of the top plate 80 and includes a lock 110, a torsion spring 190 and a molded steel plate 200. The torsion spring 190 creates a counter-clockwise torsion force that keeps the molded steel plate 200 in constant contact with a surface of the handle 60 during opening and closing of the cart. A shoulder screw 310 connects the lock 110 and the torsion spring 190, allowing the lock 110 to rotate about its vertical axis. The locking mechanism secures the platform 20 in position when the cart is unfolded and operational, or collapsed for storage and/or transport.

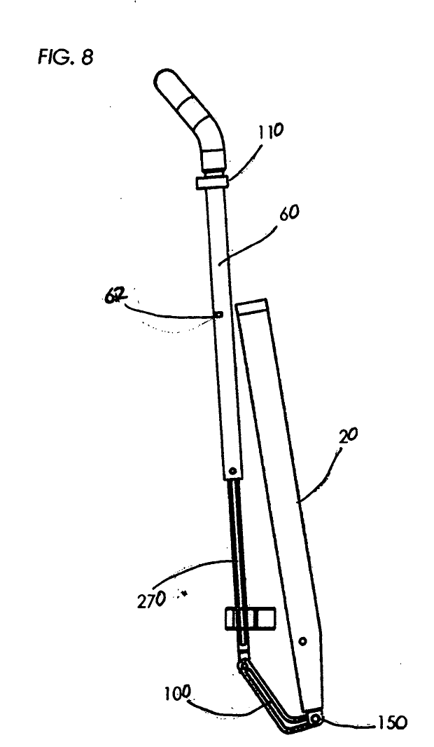

To open the cart 1 from its collapsed (storage) configuration, the lock 110 is rotated about its vertical axis, disengaging the molded steel plate 200 from contact with an upright member of the handle 60. The handle 60 is then pulled vertically in an upward direction, moving the upright members of the handle 60 upward through the openings in the top plate 80. The linear motion of the handle is converted to radial motion as the upright members of the handle 60 pull up the guiders 270, which in turn pull up the top end of the hinges 100 causing the elbow of the hinges to pull backwards and slightly upwards, resulting in the platform 20 unfolding to a horizontal position. FIGS. 8 and 5 show the configuration of the handle 60 and the attached linkages when the platform 20 is in a horizontal, operational position and when the platform 20 is in a vertical, storage position.

To secure the cart 1 in the operational configuration, when the cart 1 is unfolded, the molded steel plate 200 is automatically inserted into slot 62 on the handle 60, by the torsion force created by the spring 190. Concurrent with the platform unfolding to a horizontal position, the container 10, along with its side support 180, also unfolds to its upright, operational position. The bottom of the container 10 is removably attached to the platform 20, such that when the platform 20 unfolds, the container 10 also unfolds and opens by following the platform 20. The container 10 is connected to the back frame assembly by way of the two vertical arms 120, 130. Openings in the right and left side edges of the container align with openings in the vertical arms 120,130 and pins or screws connect the two surfaces.

The container 10 further has a side support 180 diagonally traversing the sides and crossing the front of the container 10. The side support 180 is pivotably coupled to the base of the arms 120, 130 and provides structure to the fabric or leather container 10. The operational configuration for the container cart is shown in FIG. 1. To configure the collapsible cart 1 into a platform cart, the container bottom is disengaged from the platform 20 and folded up, such that the folded container and side support are positioned vertically abutting the back frame assembly 30.

The platform cart 1 is collapsed for storage by pulling the lock 110, such that the molded steel plate 200 disengages from slot 62. The handle 60 is pushed downward, such that pin 280 reaches and engages the lower surface of slot 271. The downward force is then transmitted from slot 271 to the guiders 270 and on to the hinges 100, resulting in the hinges 100 moving forward. The hinges 100 are attached to the pivot-bars 150, and the downward and forward force causes the pivot-bars to pivot around point 21 and lift the platform to an upright position abutting the back frame assembly 30. FIG. 8 shows the platform cart in the collapsed, upright position, such that the change in position of the handle 60, guiders 270, hinges 100 and platform 20 are demonstrated, as compared to FIG. 5. The cart 1 is locked in this position via inserting the molded steel plate 200 into slot 61.

The cart of the present invention has important advantages over the prior art carts. The cart is convertible from the storage, to the container cart, to the platform cart configurations without the need of tools or the need for additional parts. The cart may be made of various plastic components, making the cart reasonably lightweight so that it can be carried or rolled to its destination for use or storage. And, in addition, the cart easily transitions among the three configurations.

It is contemplated that features disclosed in this application, as well as those described in the above applications incorporated by reference, can be mixed and matched to suit particular circumstances. Various other modifications and changes will be apparent to those of ordinary skill.

1. A convertible cart comprising:
a back frame assembly;
a collapsible platform pivotally attached to the back frame assembly;
a plurality of wheels rotatably attached to at least one of the back frame assembly and the collapsible platform; and
a collapsible container attached to the back frame assembly and the collapsible platform, wherein the back frame assembly, the collapsible platform and the collapsible container define a partially enclosed region.

2. The convertible cart of claim 1, wherein the back frame assembly comprises:
a handle having two spaced-apart upright members and a top plate operably engaging the upright members, wherein each of the upright members have a plurality of slots formed therein;
two vertical arms operably attached to the top plate;
two guides, wherein one of the guides is attached to each of the vertical members; and
a back panel extending between and connecting to the two vertical arms.

3. The convertible cart of claim 2, wherein the top plate has a pair of openings formed therein, and wherein one of the upright members extends through each opening in the top plate to allow sliding of the handle with respect to the top plate.

4. The convertible cart of claim 2, wherein the handle further comprises a handle grip that extends between the upright members.

5. The convertible cart of claim 2, and further comprising at least one hinge that operably attaches the guides to the collapsible platform.

6. The convertible cart of claim 2, wherein each of the vertical arms has a cavity formed therein that receives a stop-bar, wherein the stop-bar extends between the vertical arms and is attached to a lower portion of the back panel.

7. The convertible cart of claim 2, wherein the top plate further comprises an integral gripping handle.

8. The convertible cart of claim 2, and further comprising a locking mechanism operably attached to the top plate, wherein the locking mechanism secures the collapsible platform in a collapsed configuration.

9. The convertible cart of claim 8, wherein the locking mechanism comprises a lock, a spring and a molded plate, wherein the molded plate is operably engaged by the force of the spring to the slots in the upright members and thus maintains the upright members in a selected relationship to the top plate.

10. The convertible cart of claim 1, and further comprising at least two wheel assemblies, wherein each of the wheel assemblies are comprised of a left wheel, a right wheel, a wheel support bracket positioned intermediate the two wheels, a pin connectedly engaged to the left wheel, wheel support bracket and right wheel, and a cap pressure-fitted to the pin.

11. The convertible cart of claim 1, wherein the collapsible container is removably attached to the back frame assembly and the collapsible platform by fastening mechanisms.

12. The convertible cart of claim 11, wherein the collapsible container further comprises a side support member, wherein the side support member is pivotally attached to the back frame assembly.

13. A convertible cart comprising:
a back frame assembly comprising:
a handle having two spaced-apart upright members and a top plate operably engaging the upright members, wherein each of the upright members have a plurality of slots formed therein;
two vertical arms operably attached to the top plate;
two guides, wherein one of the guides is attached to each of the vertical members; and
a back panel extending between and connecting to the two vertical arms;
a collapsible platform pivotally attached to the back frame assembly;
a plurality of wheels rotatably attached to at least one of the back frame assembly and the collapsible platform; and
a collapsible container attached to the back frame assembly and the collapsible platform, wherein the back frame assembly, the collapsible platform and the collapsible container define a partially enclosed region.

14. The convertible cart of claim 13, wherein the top plate has a pair of opening formed therein, and wherein one of the upright members extends through each opening in the top plate to allow sliding of the handle with respect to the top plate.

15. The convertible cart of claim 13, wherein the handle further comprises a handle grip that extends between the upright members.

16. The convertible cart of claim 13, and further comprising at least one hinge that operably attaches the guides to the collapsible platform.

17. The convertible cart of claim 13, wherein each of the vertical arms has a cavity formed therein that receives a stop-bar, wherein the stop-bar extends between the vertical arms and is attached to a lower portion of the back panel.

18. The convertible cart of claim 13, wherein the top plate further comprises an integral gripping handle.

19. The convertible cart of claim 13, and further comprising a locking mechanism operably attached to the top plate, wherein the locking mechanism secures the collapsible platform in a collapsed configuration.

20. The convertible cart of claim 19, wherein the locking mechanism comprises a lock, a spring and a molded plate, wherein the molded plate is operably engaged by the force of the spring to the slots in the upright members and thus maintains the upright members in a selected relationship to the top plate.

21. The convertible cart of claim 13, and further comprising at least two wheel assemblies, wherein each of the wheel assemblies are comprised of a left wheel, a right wheel, a wheel support bracket positioned intermediate the two wheels, a pin connectedly engaged to the left wheel, wheel support bracket and right wheel, and a cap pressure-fitted to the pin.

22. The convertible cart of claim 13, wherein the collapsible container is removably attached to the back frame assembly and the collapsible platform by fastening mechanisms.

23. The convertible cart of claim 22, wherein the collapsible container further comprises a side support member, wherein the side support member is pivotally attached to the back frame assembly.

24. A method of using the collapsible cart comprising:
providing a collapsible cart having a back frame assembly, a collapsible platform pivotally attached to the back frame assembly, and a plurality of wheels rotatably attached to at least one of the back frame assembly and the collapsible platform;
pivoting the collapsible platform with respect to the back frame assembly to an extended position; and
pivoting a collapsible container with respect to the back frame assembly to define a partially enclosed region.

25. The method of claim 24, and further comprising pulling upwardly on a handle portion of the back frame assembly to cause linear motion of the handle portion to be converted into radial motion of the collapsible platform with respect to the back frame assembly.

25. The method of claim 24, and further comprising pivoting the collapsible container towards the back frame assembly.
